(19) United States
(12) Patent Application Publication
(10) Pub. No.: US 2021/0213739 A1
(43) Pub. Date: Jul. 15, 2021

(54) LIQUID EJECTION DEVICE

(71) Applicant: MIMAKI ENGINEERING CO., LTD., Nagano (JP)

(72) Inventors: Jun Sakamoto, Nagano (JP); Misaki Watanabe, Nagano (JP); Akihiro Tsukada, Nagano (JP)

(73) Assignee: MIMAKI ENGINEERING CO., LTD., Nagano (JP)

(21) Appl. No.: 17/148,447

(22) Filed: Jan. 13, 2021

(30) Foreign Application Priority Data
Jan. 15, 2020 (JP) 2020-004037

(51) Int. Cl. B41J 2/165

(52) U.S. Cl. CPC B41J 2/16526; B41J 2002/16555; B41J 2/16552

(57) ABSTRACT

A liquid ejection device includes a liquid ejection head having a nozzle surface provided with an ejection port of a nozzle from which a liquid is ejected, a cap that comes into contact with the nozzle surface to cover the nozzle, an air pressure adjuster that adjusts an air pressure inside the cap when the cap is in contact with the nozzle surface, and a contact force adjuster that sets, equal to a first pressure, a contact force that is a pressure causing the cap to come into contact with the nozzle surface when the air pressure adjuster sets the air pressure inside the cap equal to a first air pressure, and sets the contact force equal to a second pressure lower than the first pressure when the air pressure adjuster sets the air pressure inside the cap equal to a second air pressure higher than the first air pressure.

### CROSS REFERENCE TO RELATED APPLICATIONS

This application claims the priority benefit of Japanese Patent Application No. 2020-004037, filed on Jan. 15, 2020. The entirety of the above-mentioned patent application is hereby incorporated by reference herein and made a part of this specification.

### TECHNICAL FIELD

The present disclosure relates to a liquid ejection device.

### DESCRIPTION OF THE BACKGROUND ART

In liquid ejection devices such as inkjet printers, in order to prevent a liquid (for example, ink) from drying at a distal end of a nozzle and the resultant clogging, the nozzle is airtightly covered with a cap when the nozzle is not used for a long time. Further, in order to clean the nozzle, the liquid inside the nozzle is sucked and removed through the cap that airtightly covers the nozzle as described above, periodically during the storage of the nozzle or immediately before the use of the nozzle. Attaching the cap to the nozzle for preventing the nozzle from drying and for cleaning is called capping.

For example, Japanese Unexamined Patent Publication No. 2012-176563 (i.e., Patent Literature 1) discloses an inkjet printer including a cleaning device including a capping moving mechanism for such capping.

[Patent Literature 1]: Japanese Unexamined Patent Publication No. 2012-176563.

Conventionally, a pressure that presses the end of the cap against a nozzle surface around the nozzle during capping (hereinafter, referred to as a capping pressure) is set highly enough to allow the cap and the nozzle surface to airtightly come into contact with each other against an air pressure difference between the inside and outside of the cap generated by suction during cleaning, regardless of whether the capping is for storage or for cleaning.

Such a high pressure is useful for cleaning the nozzle, but for the storage of the nozzle, the pressure may cause damage to the nozzle surface and a structure around the nozzle surface. For example, an antifouling layer (for example, a water-repellent layer) for preventing adhesion of a liquid ejected from the nozzle is often applied to the nozzle surface, but the capping with the above-described high pressure may cause such an antifouling layer to crack or come off. Further, for example, for an inkjet printer, a multilayered body made of metal plates engraved with a fine nozzle structure and an ink flow path may be employed as a print head, but when the high pressure continues to be applied from the cap to the multilayered body in the layering direction, the multilayered body may crack at a boundary between adjacent metal plates or at a boundary between a metal plate and a part made of a different material.

### SUMMARY

In view of the above, the present disclosure provides a liquid ejection device that allows suitable capping.

A liquid ejection device according to a first aspect of the present disclosure includes: a liquid ejection head having a nozzle surface provided with an ejection port of a nozzle from which a liquid is ejected, a cap that comes into contact with the nozzle surface to cover the nozzle, an air pressure adjuster configured to adjust an air pressure inside the cap when the cap is in contact with the nozzle surface, and a contact force adjuster configured to: set a contact force equal to a first pressure, in which the contact force is a pressure causing the cap to come into contact with the nozzle surface when the air pressure adjuster sets the air pressure inside the cap to a first air pressure, and set the contact force to a second pressure lower than the first pressure when the air pressure adjuster sets the air pressure inside the cap to a second air pressure smaller in absolute value than the first air pressure.

This structure can optimize the contact force causing the cap to come into contact with the nozzle surface according to the air pressure inside the cap, so that capping can be suitably made. For example, a capping pressure when the nozzle is stored may be set lower than a capping pressure when the nozzle is cleaned, so that it is possible to keep, for the cleaning of the nozzle, a sufficient airtight sealing force between the cap and the nozzle surface and to more preferably store the nozzle with less damage to the nozzle surface and the liquid ejection head, for example.

The liquid ejection device may further include: a moving device configured to move the liquid ejection head between a printing position where the liquid is ejected from the liquid ejection head for predetermined printing and a maintenance position where the nozzle surface faces an opening of the cap, and the liquid ejection device may be configured such that the moving device moves the liquid ejection head from the printing position to the maintenance position during or after printing, and then the contact force adjuster sets the contact force to the first pressure and the air pressure adjuster sets the air pressure inside the cap to the first air pressure to cause the liquid to be ejected from the nozzle.

This structure can optimize the contact force causing the cap to come into contact with the nozzle surface according to the air pressure inside the cap, so that capping can be suitably made.

The liquid ejection device may further include: a moving device configured to move the liquid ejection head between a printing position where the liquid is ejected from the liquid ejection head for predetermined printing and a maintenance position where the nozzle surface faces an opening of the cap, and the liquid ejection device may be configured such that the moving device moves the liquid ejection head from the printing position to the maintenance position after process, and then the contact force adjuster sets the contact force to the second pressure and the air pressure adjuster sets the air pressure inside the cap to the second air pressure to hold the liquid inside the nozzle.

This structure can optimize the contact force causing the cap to come into contact with the nozzle surface according to the air pressure inside the cap, so that capping can be suitably made.

The liquid ejection device may further include: a moving device configured to move the liquid ejection head between a printing position where the liquid is ejected from the liquid ejection head for predetermined printing and a maintenance position where an opening of the cap faces the nozzle surface, and the liquid ejection device may be configured such that the moving device moves the liquid ejection head from the printing position to the maintenance position, and then the contact force adjuster sets the contact force to the first pressure and the air pressure adjuster sets the air pressure inside the cap to the first air pressure to fill a supply channel through which the liquid is supplied to the nozzle with the liquid.

This structure can optimize the contact force causing the cap to come into contact with the nozzle surface according to the air pressure inside the cap, so that capping can be suitably made.

The liquid ejection device may be configured such that, the contact force adjuster is configured to set the contact force applied to the cap to be equal to the first pressure, and then the air pressure adjuster is configured to set the air pressure inside the cap to be equal to the first air pressure.

This structure can optimize the contact force causing the cap to come into contact with the nozzle surface according to the air pressure inside the cap, so that capping can be suitably made.

The liquid ejection device may be configured such that, the contact force adjuster is configured to set the contact force applied to the cap to be equal to the first pressure, and at the same time, the air pressure adjuster is configured to set the air pressure inside the cap to be equal to the first air pressure.

This structure can optimize the contact force causing the cap to come into contact with the nozzle surface according to the air pressure inside the cap, so that capping can be suitably made.

The liquid ejection device may be configured such that, the contact force adjuster includes an actuator configured to move the cap in one direction toward the nozzle surface between a position where the cap comes into contact with the nozzle surface and a position where the cap is separated from the nozzle surface when the cap is in a maintenance position where an opening of the cap faces the nozzle surface.

This structure can easily optimize the contact force causing the cap to come into contact with the nozzle surface according to the air pressure inside the cap. For example, the contact force applied during the cleaning of the nozzle and the contact force applied during the storage of the nozzle can be easily adjusted to different pressures.

The liquid ejection device may be configured such that, the contact force adjuster includes a slide unit on which the cap is placed, and a guiding unit configured to hold the slide unit so as to allow the slide unit to slide in a first direction and to allow the slide unit to change a position in a second direction orthogonal to the first direction while sliding in the first direction, the guiding unit includes a first locking portion configured to hold the slide unit at a position where the cap is separated from the nozzle surface, a second locking portion configured to hold the slide unit at a position where the cap is pressed against the nozzle surface with the second pressure, and a third locking portion configured to hold the slide unit at a position where the cap is pressed against the nozzle surface with the first pressure, and the guiding unit holds the slide unit so as to allow the slide unit to slide through the first locking portion, the second locking portion, and the third locking portion in this order.

This structure can easily optimize and maintain the contact force causing the cap to come into contact with the nozzle surface according to the air pressure inside the cap. For example, the contact force applied during the cleaning of the nozzle and the contact force applied during the storage of the nozzle can be easily adjusted to and maintained at different pressures.

According to the present disclosure, capping can be suitable made.

### BRIEF DESCRIPTION OF THE DRAWINGS

FIG. 1 is an overall view of an inkjet printer according to an embodiment of the present disclosure.

FIG. 2 is a block diagram of a structure inside a device body shown in FIG. 1.

FIG. 3A is a cross-sectional view of an inkjet head taken along a lateral direction.

FIG. 3B is a cross-sectional view of the inkjet head taken along a longitudinal direction.

FIG. 4A is a plan view of a head cap. FIG. 4B is a cross-sectional view of the head cap taken along the lateral direction. FIG. 4C is a cross-sectional view of the head cap taken along the longitudinal direction.

FIG. 5A is a cross-sectional view, taken along the lateral direction, of the inkjet head against which the head cap is pressed. FIG. 5B is a cross-sectional view, taken along the longitudinal direction, of the inkjet head against which the head cap is pressed.

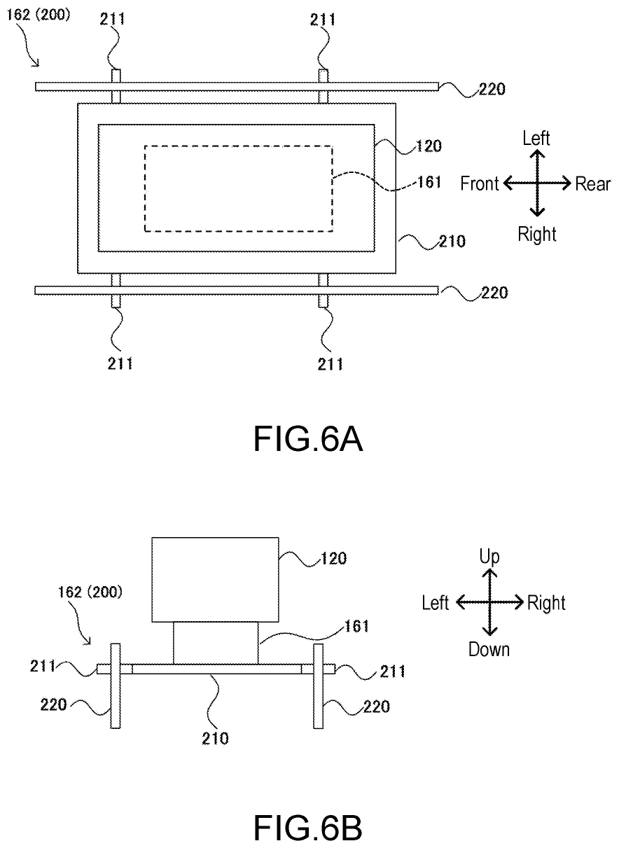

FIG. 6A is a plan view of a head cap moving mechanism according to a modification.

FIG. 6B is a front view of the head cap moving mechanism according to the modification. FIG. 6C is a side view of the head cap moving mechanism according to the modification.

FIG. 7A is a side view of the head cap moving mechanism according to the modification when the head cap is separated from the inkjet head. FIG. 7B is a side view of the head cap moving mechanism according to the modification when the head cap is pressed against the inkjet head with a first pressure. FIG. 7C is a side view of the head cap moving mechanism according to the modification when the head cap is pressed against the inkjet head with a second pressure.

FIG. 8A is a cross-sectional view, taken along the lateral direction, of the inkjet head against which the head cap is pressed according to the modification. FIG. 8B is a cross-sectional view, taken along the longitudinal direction, of the inkjet head against which the head cap is pressed according to the modification.

### DESCRIPTION OF EMBODIMENTS

(Structure of Inkjet Printer 10)

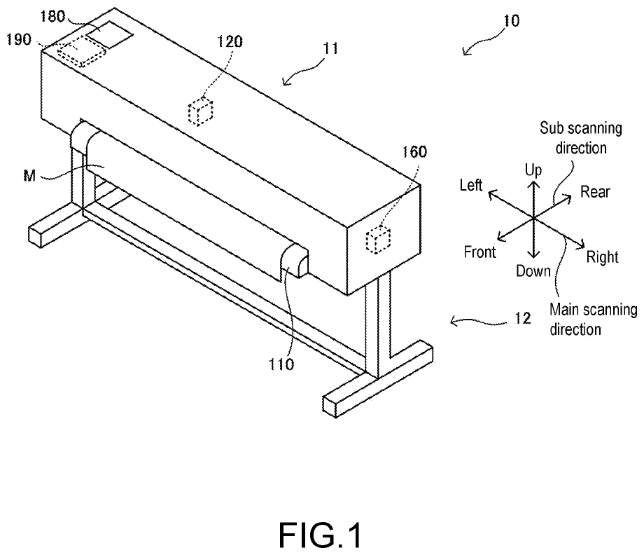

An inkjet printer 10 according to an embodiment of the present disclosure has an appearance shown in FIG. 1 and prints an image on a medium M by an inkjet method. The medium M is, for example, a sheet material such as paper or fabric. The inkjet printer 10 includes a device body 11 and a frame 12. The device body 11 is a part where an image is printed on the medium M and that is supported by the frame 12.

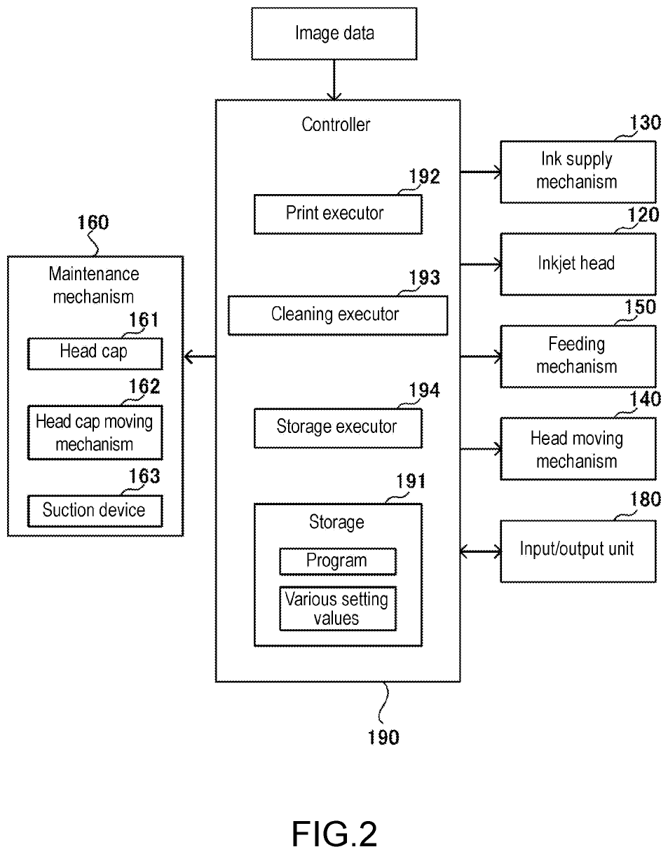

The device body 11 includes a platen 110 that supports the medium M. The device body 11 further includes, therein, an inkjet head 120, an ink supply mechanism 130, a head moving mechanism 140, a feeding mechanism 150, a maintenance mechanism 160, an input/output unit 180, and a controller 190 (see also FIG. 2).

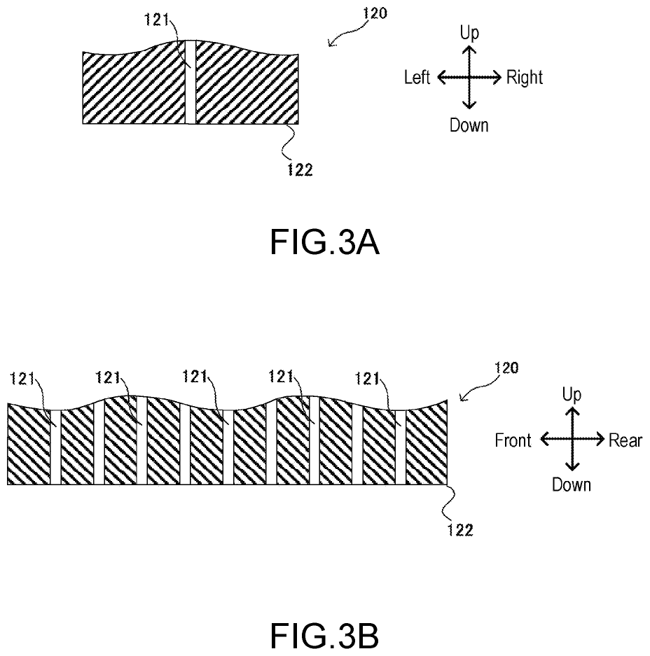

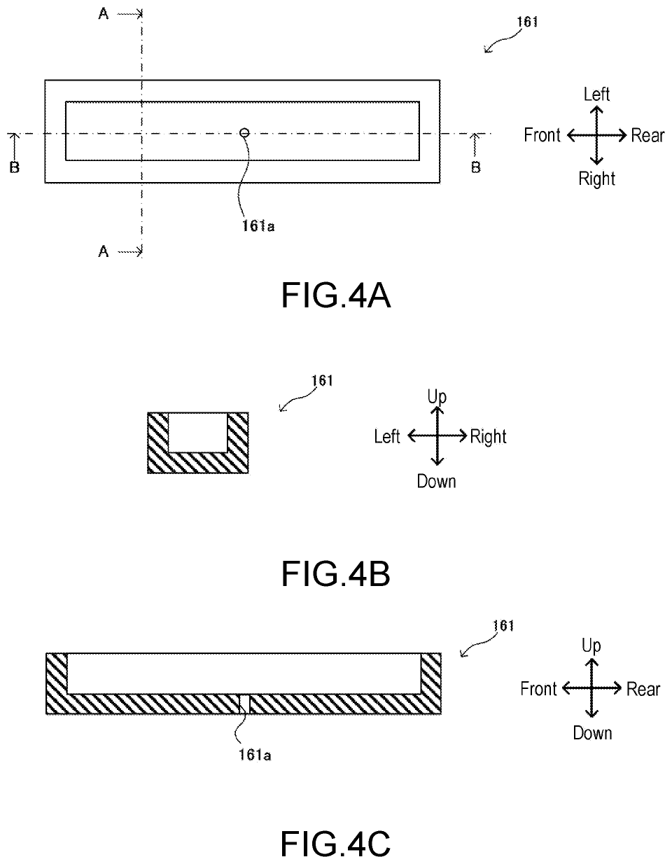

When printing an image, the inkjet head 120 ejects a printing ink onto the medium M by an inkjet method (may be either a piezoelectric method or a thermal head method). The printing ink corresponds to, for example, each of the YMCK inks. As shown in FIG. 3A to FIG. 3B, the inkjet head 120 includes a nozzle 121 that ejects ink fed from an ink tank via an ink supply mechanism 130 to be described later, and a nozzle surface 122 on which the nozzle 121 opens.

The ink supply mechanism 130 has an ink supply channel and supplies the ink in the ink tank such as an ink bottle or an ink cartridge to the inkjet head 120 through the ink supply channel.

The head moving mechanism 140 moves the inkjet head 120 between a printing position and a maintenance position to be described later, for example, in a left-right direction, that is, in a main scanning direction. The head moving mechanism 140 includes a carriage on which the inkjet head 120 is mounted, and a guide rail that guides the carriage in the left-right direction. The head moving mechanism 140 further includes a driving belt to which the carriage is fastened, a driving pulley and a driven pulley around which the driving belt is wound, and a driving motor that rotates the driving pulley. The rotation of the driving motor rotates the driving belt to move the carriage in the left-right direction.

The feeding mechanism 150 is a mechanism for feeding the medium M in a sub scanning direction that is a front-rear direction. The feeding mechanism 150 includes a driving motor, a driving roller to be rotated by the driving motor, and a plurality of pinch rollers. The medium M is sandwiched between the driving roller and the plurality of pinch rollers and is fed in the sub scanning direction by the rotation of the driving roller.

The maintenance mechanism 160 cleans the nozzle 121 and stores the nozzle 121. The cleaning is made on a regular basis.

The maintenance mechanism 160 includes a head cap 161, a head cap moving mechanism 162, and a suction device 163. The maintenance mechanism 160 is disposed at one end of the device body 11 in the left-right direction (for example, at the right end in FIG. 1).

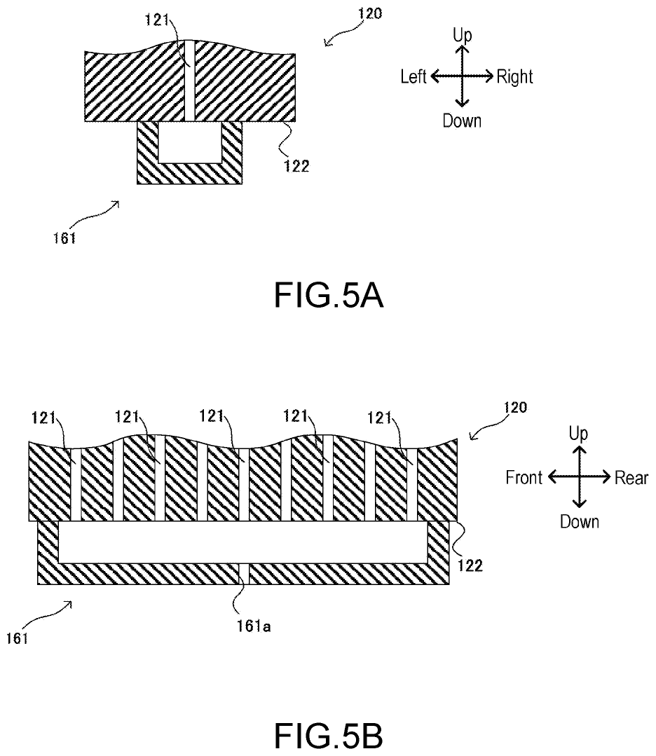

The head cap 161 is a member having an approximately cup shape with an opening formed at one end, for example, a box shape with an upward opening as shown in FIG. 4A to FIG. 4C. When an end of the opening of the head cap 161 comes into contact with the nozzle surface 122, the head cap 161 airtightly covers the nozzle 121 provided through the nozzle surface 122. The head cap 161 includes a discharging port 161a extending through a bottom portion of the head cap 161, and the discharging port 161a is in fluid communication with the suction device 163.

The head cap moving mechanism 162 moves the head cap 161 to press the head cap 161 against the nozzle surface 122 of the inkjet head 120 with a predetermined pressure to bring the head cap 161 into contact with the nozzle surface 122 or to separate the head cap 161 from the nozzle surface 122. Therefore, the head cap moving mechanism 162 includes an actuator that moves, when the inkjet head 120 is in the maintenance position for maintenance of the nozzle 121 (for example, at the right end in FIG. 1), the head cap 161 in one direction toward the nozzle surface 121, for example, in an up-down direction. When the inkjet head 120 is in the maintenance position, the nozzle surface 162 of the inkjet head 120 and the opening of the head cap 161 face each other.

A first pressure is equal to or higher than a pressure that causes the head cap 161 and the nozzle surface 122 to airtightly come into contact with each other against an air pressure difference generated between the inside and outside of the head cap 161 when an air pressure inside the head cap 161 is equal to a first air pressure to be described later during the cleaning of the nozzle 121.

A second pressure is a pressure that is lower than the first pressure and causes the head cap 161 and the nozzle surface 122 to airtightly come into contact with each other against an air pressure difference occurring between the inside and outside of the head cap 161 when the air pressure inside the head cap 161 is equal to a second air pressure to be described later during the storage of the nozzle 121. Usually, this air pressure difference is approximately 0 Pa, so that the second pressure needs to be equal to or higher than 0 Pa.

The suction device 163 sucks air inside the head cap 161 to set the air pressure inside the head cap 161 equal to a predetermined air pressure where an ejection nozzle is airtightly covered. When the nozzle 121 of the inkjet head 120 is cleaned, the suction device 163 adjusts an air pressure inside the head cap 161 to the first air pressure that causes ink remaining inside the nozzle 121 of the inkjet head 120 to be sucked out. In particular, the first air pressure is a negative pressure lower than the air pressure outside the head cap 161. On the other hand, when the nozzle 121 of the inkjet head 120 is stored, stopping the suction of air inside the head cap 161 to allow air to flow from the suction device 163 into the head cap 161 adjusts the air pressure inside the head cap 161 to the second air pressure that causes ink to be held inside the nozzle 121 of the inkjet head 120. As long as the second air pressure is smaller in absolute value than the first air pressure, the second air pressure may be equal to, higher than, or lower than the air pressure outside the head cap 161. Here, the first air pressure and second air pressure are values based on the air pressure outside the head cap 161.

The input/output unit 180 displays various images and receives an operation input from a user (including an operator) under the control of the controller 190. The input/output unit 180 includes, for example, a touchscreen. The various images to be displayed by the input/output unit 180 include an image representing operation units (operation buttons, etc.) for receiving the operation input from the user. The input/output unit 180 may include a display unit such as a liquid crystal monitor and an operation unit such as an operation switch.

The controller 190 controls the whole of the inkjet printer 10. The controller 190 includes various computers such as a microcomputer that operates in accordance with a program. Further, the controller 190 is capable of communicating with an external host computer or the like, and image data is supplied to the controller 190.

As shown in FIG. 2, the controller 190 includes a storage 191, a print executor 192, a cleaning executor 193, and a storage executor 194.

The storage 191 includes various storage devices such as a hard disk drive (HDD) or a solid state drive (SSD). The storage 191 stores a program to be executed by the controller 190 and various setting values to be used during the execution of the program. The storage 191 may include a random access memory (RAM) serving as a main memory of a processor to be described later.

The print executor 192, the cleaning executor 193, and the storage executor 194 each include various processors such as a central processing unit (CPU) that executes the program stored in the storage 191.

The print executor 192 controls the inkjet head 120, the head moving mechanism 140, and the feeding mechanism 150 on the basis of the image data supplied from the outside of the inkjet printer 10 (host computer, etc.) to print an image represented by the image data on the medium M. The print executor 192 controls, while driving the head moving mechanism 140 to move the inkjet head 120, the inkjet head 120 to eject ink at a timing based on image data. Such a process causes one line of the image represented by the image data to be printed. Subsequently, the print executor 192 drives the feeding mechanism 150 to feed the medium M by a predetermined distance in the sub scanning direction. Accordingly, repeatedly printing each line of the image, causing the feeding mechanism 150 to feed the medium M, and the like cause the image to be printed on the medium M.

The cleaning executor 193 controls the head moving mechanism 140 and the maintenance mechanism 160 during or after printing to clean the nozzle 121 of the inkjet head 120. Specifically, when the inkjet head 120 is not in the maintenance position, the cleaning executor 193 drives the head moving mechanism 140 to move the inkjet head 120 to the maintenance position. Further, the cleaning executor 193 causes the head cap moving mechanism 162 to press the head cap 161 against the nozzle surface 122 of the inkjet head 120 with the first pressure to bring the head cap 161 into contact with the nozzle surface 122, and drives the suction device 163 to perform suction to adjust the air pressure inside the head cap 161 to the first air pressure that is a negative pressure and to cause the ink inside the nozzle 121 of the inkjet head 120 to be sucked out. Subsequently, the cleaning executor 193 separates the head cap 161 from the inkjet head 120. As described above, the nozzle 121 of the inkjet head 120 is cleaned.

After printing, the storage executor 194 controls the head moving mechanism 140 and the maintenance mechanism 160 to store the nozzle 121 of the inkjet head 120. Specifically, the storage executor 194 drives the head moving mechanism 140 to move the inkjet head 120 to the maintenance position. Further, the storage executor 194 causes the head cap moving mechanism 162 to press the head cap 161 against the nozzle surface 122 of the inkjet head 120 with the second pressure to bring the head cap 161 into contact with the nozzle surface 122, and maintains this state. At this time, the storage executor 194 stops the suction by the suction device 163 or makes the suction weaker than the suction during cleaning to adjust the air pressure inside the head cap 161 to the second pressure to hold ink inside the nozzle 121 of the inkjet head 120. As described above, the nozzle 121 of the inkjet head 120 is stored.

(Effect)

In a conventional inkjet printer, when a distal end of a nozzle is airtightly covered by a head cap for storing or cleaning the nozzle, a pressure that presses the end of the head cap against a nozzle surface around the nozzle is set, regardless of the purpose of capping, equal to a pressure that is highly enough to cause the head cap and the nozzle surface to airtightly come into contact with each other against an air pressure difference between the inside and outside of the cap generated by suction during cleaning, that is, to the first pressure according to the above-described embodiment.

The first pressure is useful for cleaning the nozzle, but in the case of storing the nozzle, the first pressure may cause damage to the nozzle surface and a structure around the nozzle surface. For example, an antifouling layer (for example, a water-repellent layer) for preventing adhesion of liquid ejected from the nozzle is often applied to the nozzle surface, but the capping with the first pressure may cause such an antifouling layer to crack or come off. Further, for example, a multilayered body made of metal plates engraved with a fine nozzle structure and an ink flow path may be employed as the print head of the inkjet printer, but when the first pressure continues to be applied from the head cap to the multilayered body in the layering direction, the multilayered body may crack at a boundary between adjacent metal plates or at a boundary between a metal plate and a part made of a different material.

On the other hand, in the inkjet printer 10 according to the above-described embodiment, during the cleaning of the nozzle 121, the head cap 161 is pressed against the nozzle surface 122 of the inkjet head 120 with the first pressure, so that, even during the suction, by the suction device 163, of ink from the nozzle 121 through the head cap 161, the head cap 161 and the nozzle surface 122 are securely and airtightly come into contact with each other. On the other hand, during the storage of the nozzle 121, the head cap 161 is pressed against the nozzle surface 122 of the inkjet head 120 with the second pressure lower than the first pressure, so that the nozzle surface 122 and the head cap 161 are less susceptible to damage, and it is safe accordingly as compared to the pressing with the first pressure. This in turn increases the production life of the head cap 161, notably the nozzle surface 122.

(Modification)

The present disclosure is not limited to the above-described embodiment. A modification of the above-described embodiment is illustrated below. Note that the structure according to the above-described embodiment and the structure according to the following modification may be combined as desired as long as there is no contradiction.

(First Modification)

According to the above-described embodiment, the inkjet printer 10 is employed as the liquid ejection device, or alternatively, any liquid ejection device including a liquid ejection head having a nozzle surface provided with an ejection port of a nozzle from which a liquid is ejected may be employed.

For example, the inkjet head 120, the ink supply mechanism 130, the head moving mechanism 140, and the feeding mechanism 150 of the inkjet printer 10 may each have a structure other than the above-described structure. Each of these mechanisms may have a known structure. Known methods may be applied to image printing, nozzle cleaning, and nozzle storage.

Further, the liquid ejection device may be a device such as a dispenser or a spray device other than an inkjet printer.

(Second Modification)

According to the above-described embodiment, the second pressure is equal to or higher than a pressure that causes the head cap 161 and the nozzle surface 122 to airtightly come into contact with each other against the air pressure difference occurring between the inside and outside the head cap 161 during the storage of the nozzle 121, but the second pressure may be lower than the pressure that causes the head cap 161 and the nozzle surface 122 to airtightly come into contact with each other as long as it is possible to prevent or suppress problems arising from drying of the ink inside the nozzle 121 during the storage of the nozzle 121 (for example, an increase in viscosity of the ink inside the nozzle 121, curing of the ink inside or around the nozzle 121, etc.).

(Third Modification)

According to the above-described embodiment, the supply channel connecting the ink supply mechanism 130 to the nozzle 121 can be filled with ink by the same operation as the cleaning of the nozzle 121.

Specifically, the controller 190 further includes a filling executor. The filling executor controls the head moving mechanism 140 and the maintenance mechanism 160 before, during, or after printing to fill the supply channel connected to the nozzle 121 of the inkjet head 120 with ink. When the inkjet head 120 is not in the maintenance position, the filling executor drives the head moving mechanism 140 to move the inkjet head 120 to the maintenance position. Further, the filling executor causes the head cap moving mechanism 162 to press the head cap 161 against the nozzle surface 122 of the inkjet head 120 with the first pressure to bring the head cap 161 into contact with the nozzle surface 122, and drives the suction device 163 to perform suction to adjust the air pressure inside the head cap 161 to the first air pressure that is a negative pressure to fill the supply channel connected to the nozzle 121 with ink. Subsequently, the filling executor separates the head cap 161 from the inkjet head 120. As described above, the supply channel connected to the nozzle 121 is filled with ink.

(Fourth Modification)

According to the above-described embodiment, the suction device 163 is used as the air pressure adjuster for adjusting the air pressure inside the head cap 161, or alternatively, any air pressure adjusting device may be employed as long as the air pressure adjuster is capable of adjusting the air pressure inside the head cap 161. For example, in a case where the air pressure inside the head cap 161 is changed from the first air pressure to the second air pressure, an air pressure adjusting device that forcibly pressurizes the inside of the head cap 161 may be used.

(Fifth Modification)

According to the above-described embodiment, the head cap moving mechanism 162 is used as the contact force adjuster that adjusts the contact force that is a pressure causing the head cap 161 to come into contact with the nozzle surface 122 according to the air pressure inside the head cap 161, or alternatively, any mechanism may be employed as long as the mechanism is capable of adjusting the contact force as described above. Note that the contact force refers to a pressure applied to a part where the head cap 161 and the nozzle surface 122 come into contact with each other.

For example, according to the above-described embodiment, the head cap moving mechanism 162 includes the actuator as a mechanism that moves the head cap 161 to press the head cap 161 against the nozzle surface 122 of the inkjet head 120 with the first pressure and the second pressure to bring the head cap 161 into contact with the nozzle surface 122 or to separate the head cap 161 from the nozzle surface 122, or alternatively, may include another moving mechanism having the same capability.

For example, the head cap moving mechanism 162 may include a cam mechanism instead of the above-described actuator. One specific example of such a cam mechanism will be described below.

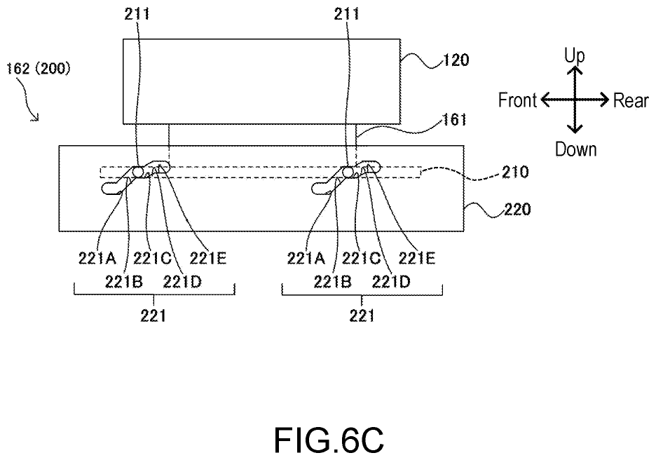

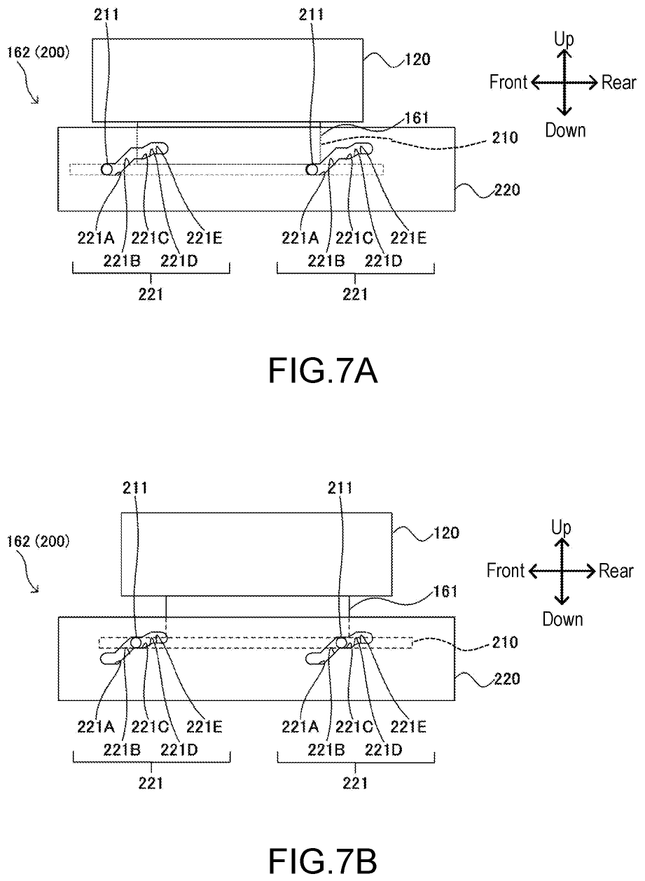

According to the present modification, the head cap moving mechanism 162 includes a cam mechanism 200, as shown in FIG. 6A to FIG. 6C. The cam mechanism 200 includes a slide unit 210, a guiding unit 220, and a driving unit (not shown).

The slide unit 210 has the head cap 161 placed thereon and is slidably supported between a set of the guiding units 220, and the slide unit 210 has, for example, a plate shape. Two sets of slide pins 211 protrude from side surfaces of the slide unit 210 and are each slidably fitted into a corresponding cam groove 221. A button may be provided at a distal end of each slide pin 211 protruding through the cam groove 221 to prevent the slide pin 211 from falling out of the cam groove 221.

The set of guiding units 220 has, for example, a plate shape, and each guiding unit 220 includes two cam grooves 221 provided at the same height. In each cam groove 221, a corresponding slide pin 211 is slidably fitted. The cam groove 221 includes three locking portions 221A, 221C, 221E extending in the horizontal direction (in the front-rear direction in FIG. 6A to FIG. 6C), a transition portion 221B that diagonally connects the locking portion 221A and the locking portion 221C, and a transition portion 221D that diagonally connects the locking portion 221C and the locking portion 221E. The locking portions 221A, 221C, 221E are arranged at different heights in the vertical direction (in the up-down direction in FIG. 6A to FIG. 6C), with the locking portion 221A provided at the lowest position, the locking portion 221E provided at the highest position, and the locking portion 221C provided between the locking portion 221A and the locking portion 221E.

The driving unit is any drive mechanism that moves the slide unit 210 in the horizontal direction when the inkjet head 120 is in the maintenance position. The movement of the slide unit 210 is restricted by the shape of the cam grooves 221 via the slide pins 211. Since the slide pins 211 move in the horizontal direction in the locking portions 221A, 221C, 221E, when the slide pins 211 are located in the locking portions 221A, 221C, 221E, the slide unit 210 moves in the horizontal direction. Since the slide pins 211 move diagonally in the transition portions 221B, 221D, when the slide pins 211 are located in the transition portions 221B, 221D, the slide unit 210 moves diagonally, that is, moves in the horizontal direction while changing in position in the vertical direction.

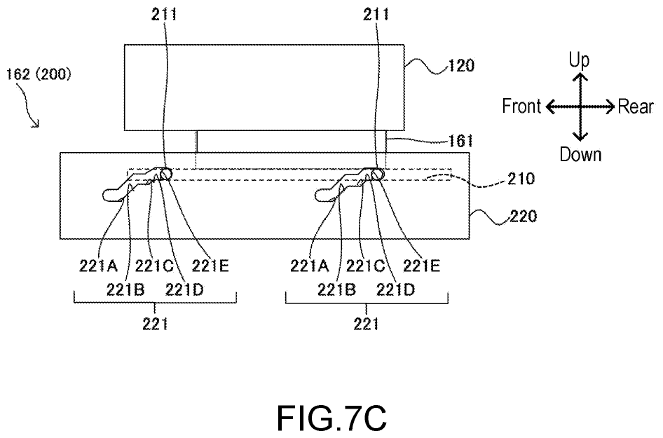

A positional relationship between the locking portion 221A and the inkjet head 120 located in the maintenance position (specifically, a distance between the nozzle surface 122 of the inkjet head 120 and the locking portion 221A) is designed such that the head cap 161 is separated from the nozzle surface 122 when each slide pin 211 is located in the locking portion 221A as shown in FIG. 7A.

A positional relationship between the locking portion 221C and the inkjet head 120 located in the maintenance position (specifically, a distance between the nozzle surface 122 of the inkjet head 120 and the locking portion 221C) is designed such that the head cap 161 is pressed against the nozzle surface 122 with the second pressure when each slide pin 211 is located in the locking portion 221C as shown in FIG. 7B.

A positional relationship between the locking portion 221E and the inkjet head 120 located in the maintenance position (specifically, a distance between the nozzle surface 122 of the inkjet head 120 and the locking portion 221E) is designed such that the head cap 161 is pressed against the nozzle surface 122 with the first pressure when each slide pin 211 is located in the locking portion 221E as shown in FIG. 7C.

Further, the cam mechanism 200 may be another moving mechanism as long as the slide unit 210 has the head cap 161 placed thereon, and the guiding units 220 holds the slide unit 210 so as to allow the slide unit 210 to slide in one direction and to allow the slide unit 210 to change a position in a different direction orthogonal to the one direction while sliding in the one direction.

For example, the guiding units 220 may be each provided with the slide pin 211 instead of each cam groove 221, and the slide unit 210 may be provided with the cam groove 221 instead of each slide pin 211.

Alternatively, for example, the guiding units 220 are each provided with a rail 222 protruding from a surface of the guiding unit 220 facing the slide unit 210 instead of each cam groove 221, and the slide unit 210 is provided with, in stead of each slide pin 211, a set of rollers 212 between which the rail 222 is interposed in the vertical direction to allow the rollers 212 to move along the rail 222.

(Sixth Modification)

According to the above-described embodiment, the head cap moving mechanism 162 serving as the contact force adjuster adjusts the contact force, and then the suction device 163 serving as the air pressure adjuster adjusts the air pressure inside the head cap 161, but the timing at which the contact force adjuster adjusts the contact force and the timing at which the air pressure adjuster adjusts the air pressure are determined as desired. After the air pressure adjuster adjusts the air pressure to the predetermined air pressure (for example, the first air pressure), the contact force adjuster may adjust the contact force to the predetermined pressure (for example, the first pressure), or alternatively, these adjustments may be made in parallel. When the adjustments are made in parallel, the air pressure adjustment made by the air pressure adjuster and the contact force adjustment made by the contact force adjuster need not either start or end at the same time.

(Seventh Modification)

The shapes, materials, and structures of the head cap 161 and nozzle surface 122 are determined as desired as long as the head cap 161 and the nozzle surface 122 airtightly come into contact with each other when the head cap 161 is pressed against the nozzle surface 122 with the second pressure.

The material of the head cap 161 may be an elastic material (for example, resin (rubber or the like)) or a rigid material (for example, metal). Further, some of the head cap 161 may be made of an elastic material, and the other may be made of a rigid material.

The surface shape of the nozzle surface 122 that comes into contact with the head cap 161 and the surface shape of the head cap 161 that comes into contact with the nozzle surface 122 are determined as desired. For example, on the nozzle surface 122 that comes into contact with the head cap 161 and/or on the surface of the head cap 161 that comes into contact with the nozzle surface 122, a recess or protrusion may be provided. Further, when the nozzle surface 122 that comes into contact with the head cap 161 and the surface of the head cap 161 that comes into contact with the nozzle surface 122 are flat, a positional relationship between the two surfaces when the inkjet head 120 is in the maintenance position need not necessarily be parallel.

On the nozzle surface 122 that comes into contact with the head cap 161 and/or on the surface of the head cap 161 that comes into contact with the nozzle surface 122, an elastic material layer made of the above-described elastic material may be provided. For example, as shown in FIG. 7C, the head cap 161 is compressed in the vertical direction, but according to the third modification, the head cap 161 may be entirely elastic, or alternatively, may be mostly rigid, but a part that comes into contact with the nozzle surface 122 is the above-described elastic material layer.

Further, between the head cap 161 and the head cap moving mechanism 160 (for example, between the head cap 161 and the slide unit 210 according to the third modification), an elastic structure such as an elastic material layer or a spring made of the above-described elastic material may be provided.

(Eighth Modification)

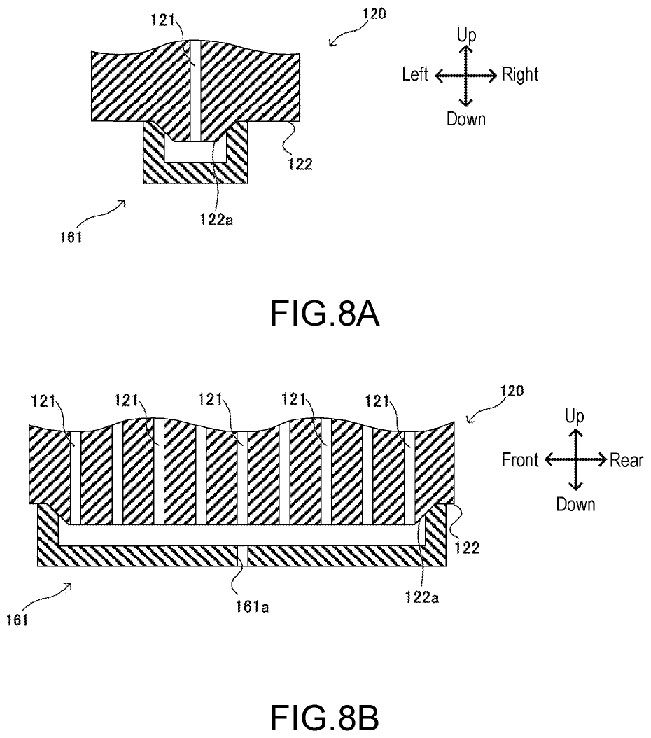

A positional relationship between the nozzle 121 and the nozzle surface 122 is determined as desired as long as the nozzle surface 122 is formed around the nozzle 121. For example, as shown in FIG. 8A and FIG. 8B, the nozzle 121 may have an opening on a protrusion 122a provided on the nozzle surface 122. On the contrary, the nozzle 121 may have an opening on a recess provided on the nozzle surface 122.

(Ninth Modification)

According to the above-described embodiment, during operations such as cleaning, storage, and filling, the contact force that causes the head cap 161 to come into contact with the nozzle surface 122 is optimized according to the air pressure inside the head cap 161, but such optimization of the contact force applied for capping is not limited to these operations and is widely applicable to any operation that needs to bring the head cap 161 into contact with the nozzle surface 122 and to adjust the air pressure inside the head cap 161 to the predetermined air pressure. In this case, the first air pressure and the second air pressure may be determined according to the operations, and in particular, the first air pressure need not be a negative pressure in a manner that depends on the operations. According to the present modification, the contact force applied to the head cap 161 can be optimized according to the operations.

What is claimed is:

1. A liquid ejection device comprising:
a liquid ejection head, having a nozzle surface provided with an ejection port of a nozzle from which a liquid is ejected;
a cap that comes into contact with the nozzle surface to cover the nozzle;
an air pressure adjuster, configured to adjust an air pressure inside the cap when the cap is in contact with the nozzle surface; and
a contact force adjuster, configured to:
set a contact force equal to a first pressure, wherein the contact force is a pressure causing the cap to come into contact with the nozzle surface when the air pressure adjuster sets the air pressure inside the cap equal to a first air pressure, and
set the contact force equal to a second pressure lower than the first pressure when the air pressure adjuster sets the air pressure inside the cap equal to a second air pressure smaller in absolute value than the first air pressure.

2. The liquid ejection device according to claim 1, further comprising:
a moving device, configured to move the liquid ejection head between a printing position where the liquid is ejected from the liquid ejection head for predetermined printing and a maintenance position where the nozzle surface faces an opening of the cap,
wherein the moving device moves the liquid ejection head from the printing position to the maintenance position during or after printing, and then the contact force adjuster sets the contact force equal to the first pressure and the air pressure adjuster sets the air pressure inside the cap equal to the first air pressure to cause the liquid to be ejected from the nozzle.

3. The liquid ejection device according to claim 1, further comprising:
a moving device, configured to move the liquid ejection head between a printing position where the liquid is ejected from the liquid ejection head for predetermined printing and a maintenance position where the nozzle surface faces an opening of the cap,
wherein the moving device moves the liquid ejection head from the printing position to the maintenance position after process, and then the contact force adjuster sets the contact force equal to the second pressure and the air pressure adjuster sets the air pressure inside the cap equal to the second air pressure to hold the liquid inside the nozzle.

4. The liquid ejection device according to claim 1, further comprising:
a moving device, configured to move the liquid ejection head between a printing position where the liquid is ejected from the liquid ejection head for predetermined printing and a maintenance position where an opening of the cap faces the nozzle surface,
wherein the moving device moves the liquid ejection head from the printing position to the maintenance position, and then the contact force adjuster sets the contact force equal to the first pressure and the air pressure adjuster sets the air pressure inside the cap equal to the first air pressure to fill a supply channel through which the liquid is supplied to the nozzle with the liquid.

5. The liquid ejection device according to claim 2, wherein
the contact force adjuster is configured to set the contact force applied to the cap to be equal to the first pressure, and then
the air pressure adjuster is configured to set the air pressure inside the cap to be equal to the first air pressure.

6. The liquid ejection device according to claim 3, wherein
the contact force adjuster is configured to set the contact force applied to the cap to be equal to the first pressure, and then
the air pressure adjuster is configured to set the air pressure inside the cap to be equal to the first air pressure.

7. The liquid ejection device according to claim 4, wherein
the contact force adjuster is configured to set the contact force applied to the cap to be equal to the first pressure, and then
the air pressure adjuster is configured to set the air pressure inside the cap to be equal to the first air pressure.

8. The liquid ejection device according to claim 2, wherein
the contact force adjuster is configured to set the contact force applied to the cap to be equal to the first pressure, and at the same time,
the air pressure adjuster is configured to set the air pressure inside the cap to be equal to the first air pressure.

9. The liquid ejection device according to claim 3, wherein
the contact force adjuster is configured to set the contact force applied to the cap to be equal to the first pressure, and at the same time,
the air pressure adjuster is configured to set the air pressure inside the cap to be equal to the first air pressure.

10. The liquid ejection device according to claim 4, wherein
the contact force adjuster is configured to set the contact force applied to the cap to be equal to the first pressure, and at the same time,
the air pressure adjuster is configured to set the air pressure inside the cap to be equal to the first air pressure.

11. The liquid ejection device according to claim 1, wherein the contact force adjuster comprises:
an actuator, configured to move the cap in one direction toward the nozzle surface between a position where the cap comes into contact with the nozzle surface and a position where the cap is separated from the nozzle surface, when the cap is in a maintenance position where an opening of the cap faces the nozzle surface.

12. The liquid ejection device according to claim 1, wherein the contact force adjuster comprises:
a slide unit, on which the cap is placed, and
a guiding unit, configured to hold the slide unit, so as to allow the slide unit to slide in a first direction and to allow the slide unit to change a position in a second direction orthogonal to the first direction while sliding in the first direction;
wherein the guiding unit comprises:
a first locking portion, configured to hold the slide unit at a position where the cap is separated from the nozzle surface,
a second locking portion, configured to hold the slide unit at a position where the cap is pressed against the nozzle surface with the second pressure, and
a third locking portion, configured to hold the slide unit at a position where the cap is pressed against the nozzle surface with the first pressure;
wherein the guiding unit holds the slide unit so as to allow the slide unit to slide through the first locking portion, the second locking portion, and the third locking portion in this order.

13. The liquid ejection device according to claim 2, wherein the contact force adjuster comprises:
a slide unit, on which the cap is placed, and
a guiding unit, configured to hold the slide unit, so as to allow the slide unit to slide in a first direction and to allow the slide unit to change a position in a second direction orthogonal to the first direction while sliding in the first direction;
wherein the guiding unit comprises:
a first locking portion, configured to hold the slide unit at a position where the cap is separated from the nozzle surface,
a second locking portion, configured to hold the slide unit at a position where the cap is pressed against the nozzle surface with the second pressure, and
a third locking portion, configured to hold the slide unit at a position where the cap is pressed against the nozzle surface with the first pressure;
wherein the guiding unit holds the slide unit so as to allow the slide unit to slide through the first locking portion, the second locking portion, and the third locking portion in this order.

14. The liquid ejection device according to claim 3, wherein the contact force adjuster comprises:
a slide unit, on which the cap is placed, and
a guiding unit, configured to hold the slide unit, so as to allow the slide unit to slide in a first direction and to allow the slide unit to change a position in a second direction orthogonal to the first direction while sliding in the first direction;
wherein the guiding unit comprises:
a first locking portion, configured to hold the slide unit at a position where the cap is separated from the nozzle surface,
a second locking portion, configured to hold the slide unit at a position where the cap is pressed against the nozzle surface with the second pressure, and
a third locking portion, configured to hold the slide unit at a position where the cap is pressed against the nozzle surface with the first pressure;
wherein the guiding unit holds the slide unit so as to allow the slide unit to slide through the first locking portion, the second locking portion, and the third locking portion in this order.

15. The liquid ejection device according to claim 4, wherein the contact force adjuster comprises:
a slide unit, on which the cap is placed, and
a guiding unit, configured to hold the slide unit, so as to allow the slide unit to slide in a first direction and to allow the slide unit to change a position in a second direction orthogonal to the first direction while sliding in the first direction;
wherein the guiding unit comprises:
a first locking portion, configured to hold the slide unit at a position where the cap is separated from the nozzle surface,
a second locking portion, configured to hold the slide unit at a position where the cap is pressed against the nozzle surface with the second pressure, and
a third locking portion, configured to hold the slide unit at a position where the cap is pressed against the nozzle surface with the first pressure;
wherein the guiding unit holds the slide unit so as to allow the slide unit to slide through the first locking portion, the second locking portion, and the third locking portion in this order.

16. The liquid ejection device according to claim 5, wherein the contact force adjuster comprises:
a slide unit, on which the cap is placed, and
a guiding unit, configured to hold the slide unit, so as to allow the slide unit to slide in a first direction and to allow the slide unit to change a position in a second direction orthogonal to the first direction while sliding in the first direction;
wherein the guiding unit comprises:
a first locking portion, configured to hold the slide unit at a position where the cap is separated from the nozzle surface,
a second locking portion, configured to hold the slide unit at a position where the cap is pressed against the nozzle surface with the second pressure, and
a third locking portion, configured to hold the slide unit at a position where the cap is pressed against the nozzle surface with the first pressure;
wherein the guiding unit holds the slide unit so as to allow the slide unit to slide through the first locking portion, the second locking portion, and the third locking portion in this order.

17. The liquid ejection device according to claim 6, wherein the contact force adjuster comprises:
a slide unit, on which the cap is placed, and
a guiding unit, configured to hold the slide unit, so as to allow the slide unit to slide in a first direction and to allow the slide unit to change a position in a second direction orthogonal to the first direction while sliding in the first direction;
wherein the guiding unit comprises:
a first locking portion, configured to hold the slide unit at a position where the cap is separated from the nozzle surface,
a second locking portion, configured to hold the slide unit at a position where the cap is pressed against the nozzle surface with the second pressure, and
a third locking portion, configured to hold the slide unit at a position where the cap is pressed against the nozzle surface with the first pressure;
wherein the guiding unit holds the slide unit so as to allow the slide unit to slide through the first locking portion, the second locking portion, and the third locking portion in this order.

18. The liquid ejection device according to claim 7, wherein the contact force adjuster comprises:
a slide unit, on which the cap is placed, and
a guiding unit, configured to hold the slide unit, so as to allow the slide unit to slide in a first direction and to allow the slide unit to change a position in a second direction orthogonal to the first direction while sliding in the first direction;
wherein the guiding unit comprises:
a first locking portion, configured to hold the slide unit at a position where the cap is separated from the nozzle surface,
a second locking portion, configured to hold the slide unit at a position where the cap is pressed against the nozzle surface with the second pressure, and
a third locking portion, configured to hold the slide unit at a position where the cap is pressed against the nozzle surface with the first pressure;
wherein the guiding unit holds the slide unit so as to allow the slide unit to slide through the first locking portion, the second locking portion, and the third locking portion in this order.
